(19) United States
(12) Patent Application Publication
(10) Pub. No.: US 2014/0244757 A1
(43) Pub. Date: Aug. 28, 2014

(54) SYSTEMS AND METHODS FOR THE ONLINE PRESENTATION AND COMMERCE OF GOODS

(71) Applicants: Deborah Hecht, Las Vegas, NV (US); Timothy Rhodes, Las Vegas, NV (US)

(72) Inventors: Deborah Hecht, Las Vegas, NV (US); Timothy Rhodes, Las Vegas, NV (US)

(21) Appl. No.: 14/203,334

(22) Filed: Mar. 10, 2014

Related U.S. Application Data
(63) Continuation of application No. 14/046,839, filed on Oct. 4, 2013, now abandoned.
Application No. 14/046,839 is a continuation of application No. 13/712,864, filed on Dec. 12, 2012, now abandoned.
Application No. 13/712,864 is a continuation of application No. 12/821,052, filed on Jun. 22, 2010, now abandoned.
(60) Provisional application No. 61/220,578, filed on Jun. 26, 2009.

(51) Int. Cl. H04L 29/06

(52) U.S. Cl. CPC H04L 65/403
USPC 709/204

(57) ABSTRACT

The invention is generally directed to systems and methods for online product presentation, and more particularly to systems and methods for the interactive live/real-time online presentation and commerce of small products. One preferred embodiment is an online computing system that enables the interactive live/real-time presentation of small products of value with intricate detail such as jewelry or precious stones on client computing devices communicatively coupled to a wide area network, such as the Internet. The system includes a conferencing system having a video conferencing session communicatively coupled to the wide area network; a computer connected to a web cam, wherein the computer communicatively couples the web cam to the video conferencing session through the wide area network, and further wherein the web cam has a lens directed at the product; and a light box substantially surrounding said product.

### RELATED APPLICATION DATA

This application is a continuation of U.S. Ser. No. 14/046,839, filed Oct. 4, 2013, which is a continuation of U.S. Ser. No. 13/712,864, filed Dec. 12, 2012, which is a continuation of U.S. Ser. No. 12/821,052, filed Jun. 22, 2010, now abandoned, which claims priority to U.S. Provisional Application No. 61/220,578, filed on Jun. 26, 2009, the entire contents and disclosure of which is herein incorporated by reference.

### FIELD OF THE INVENTION

The field of the invention relates to systems and methods for online product presentation, and more particularly to systems and methods for live online presentation and commerce of small goods, possibly of value or having intricate detail.

### BACKGROUND OF THE INVENTION

For the wholesale of valuable finished goods and/or goods having intricate detail, such as jewelry, precious stones, or pens, best business practices are traditionally conducted in person. Because some of these goods can be very expensive and rare, a live, interactive meeting between the seller and the buyer not only gives the buyer an opportunity to carefully inspect the actual product(s), but it also allows the parties to communicate face to face and create a trusting personal connection. When merchandise is being considered for purchase, integrity and the building of this personal connection and rapport is essential to conducting business. However, due to ever increasing costs (such as energy, personnel, and insurance) and security risks involved in traveling with such valuable goods (e.g. wholesalers being “held up” while traveling), such increasingly dangerous business practices are on the decline, leading to less business and fewer sales. In the retail world, the personal relationship between expert sales staff and consumers is what makes the business (i.e. sales) happen. However, for several reasons the consumer is visiting their expert sales person or retail store less frequently, and therefore causing less sales. This can be due to the consumers being seasonal, the consumer relocating or because the consumer simply does not enjoy traveling what may be a great distance to purchase goods. In the alternative, such goods can be made available for a passive sale online with detailed photos and videos on display; however, many consumers are hesitant to use existing online systems to make important personal investments in such an impersonal and perhaps untrustworthy environment because there is no live sales person present to assure the consumer, to answer questions and to otherwise conduct and complete a proactive sale.

Accordingly, improved systems and methods for displaying and selling small goods, particularly valuable finished goods and materials are more desirable when linked with a live, interactive sales person with whom they can interact.

### SUMMARY OF THE INVENTION

The invention is generally directed to systems and methods for live/real time, interactive online high resolution product presentations, and more particularly to systems and methods for live/real time, interactive online high resolution presentations and commerce of small goods, such small goods possibly being of intrinsic value and intricate design. It packages both the audio and interactive live/real time high resolution visual practices necessary to assure the customer-sales staff relationship and complete the sale.

One preferred embodiments is an online computing system that enables the live/real-time, interactive online high resolution presentation of products such as jewelry, pens, or precious stones on client computing devices communicatively coupled to a wide area network, such as the Internet. The system includes a collaborative conferencing system communicatively coupled to the wide area network having live video conferencing capabilities; a computer connected to a high resolution camera, wherein the computer communicatively couples the camera to said live video conferencing through the wide area network, and further wherein the camera has a lens directed at the product; and a light box substantially housing said product.

Another preferred embodiment is a method that provides a real-time, online presentation of products on client computing devices communicatively coupled to a wide area network, such as the Internet. The method includes the steps of establishing a live/interactive conferencing session with the client computing devices, including a live video conference, using a conferencing system communicatively coupled to the wide area network; coupling a high resolution camera to the video conference through the wide area network; directing said high resolution camera at said product; and providing a light box that substantially surrounds said product.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is an exemplary diagram of an online presentation system in accordance with a preferred embodiment of the present invention.

FIG. 2 is an exemplary diagram of an online product presentation system in accordance with a preferred embodiment of the present invention.

FIG. 3 is a diagram of a process in accordance with a preferred embodiment of the present invention.

FIG. 4 is an exemplary diagram of a user interface of the online product presentation system in accordance with a preferred embodiment of the present invention.

FIG. 5a is a top view of a support stand in accordance with a preferred embodiment of the present invention.

FIG. 5b is a front view of a support stand in accordance with a preferred embodiment of the present invention.

FIG. 6 is a view of a camera used in the online product presentation system in accordance with a preferred embodiment of the present invention.

FIG. 7 is a view of a connector device used in the online product presentation system in accordance with a preferred embodiment of the present invention.

### DETAILED DESCRIPTION OF THE PREFERRED EMBODIMENTS

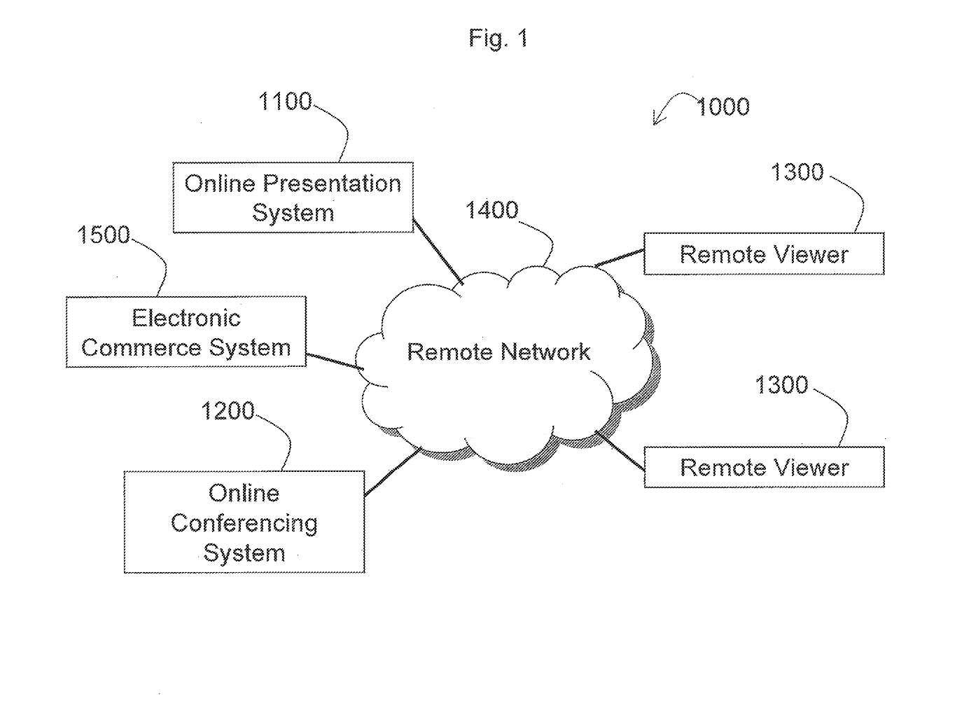

Turning to FIG. 1, a system 1000 in accordance with a preferred embodiment of the invention is shown. The system 1000 includes an online presentation system 1100 that is communicatively coupled to a wide area network 1400, such as the Internet. Also included is a conferencing system 1200 communicatively coupled to the online presentation system 1100 via the wide area network 1400. The conferencing system 1200 is a set of interactive telecommunication technologies known in the art, including live/interactive video conferencing, that allow one or more computing devices at remote locations, e.g., remote viewers 1300 (which generally includes any network enabled computing device with a display, such as a personal computer, tablet, or smart phone) and the online presentation system 1100, to interact, e.g., via display or desktop sharing and/or two-way video and audio transmissions, simultaneously through the wide area network 1400, such as the Internet. Examples of systems, which are also known as online collaborative systems, include Cisco's Webex, Microsoft's NetMeeting, GoTo Meeting, Live Office, and Skype. An example of such a system is described in U.S. Pat. No. 6,567,813 to Zhu et al., which is herein incorporated by reference in its entirety. Also included in the system 1000 is an electronic c01mnerce system 1500 that enables the participants to initiate and complete payment transactions, such as PayPal. An example of such a system is described in U.S. Pat. No. 7,089,208, which is herein incorporated by reference in its entirety.

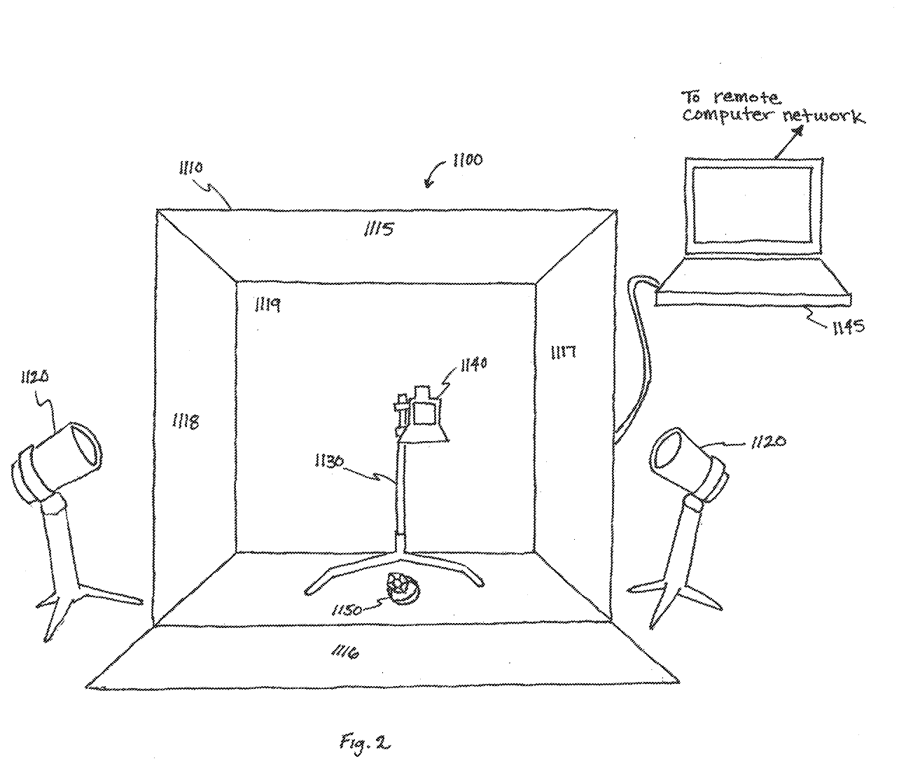

An exemplary online presentation system 1100 is shown in FIG. 2. The system 1100 includes a camera 1140 communicatively coupled to a computer 1145 that is communicatively coupled to the wide area network 1400, either through a wired connection or wireless LAN connection, such as an 802.11 connection; a wireless PAN connection, such as a Bluetooth connection, a wide area network connection, such as Nortel's LTE or Wi-MAX connection; or a cell connection, such as a CDMA or GSM connection. Using a wireless network increases the portability of the online presentation system 1100, thereby giving the presenter greater flexibility as to location to conduct the online presentation.

The camera 1140 is preferably a webcam, for example, Logitech's Quickcam Pro 9000, which is a camera designed to transmit digital video and photos directly to a computing device, e.g., 1145, which can store such video and photos for transmission over the wide area network 1400 to a remote device, e.g., remote viewer 1300. As one of skill in the art can appreciate, higher amounts of data may be required to represent higher quality/resolution photos and video (even with compression); however, higher amounts of data will take longer to transmit, particularly over networks of limited bandwidth (e.g., wireless networks as compared to wired networks), thereby affecting the performance of the real-time display. Webcams are generally designed to balance between the two requirements, i.e., high quality/resolution videos and photos vs. transmission performance.

The webcam preferably provides video streaming and recording in addition to photo capture. Further, the webcam and associated software preferably provides not only contrast, brightness, and color-intensity controls, but also exposure and gain controls (e.g., Logitech's Quickcam Pro 9000) as well to maximize the depth of field, as one of ordinary skill in the art would appreciate. Particularly for goods with intricate detail, e.g. diamonds having multiple cuts and facets, it is crucial that such detail fall within the depth of field of the camera 1140 so as to provide clarity and quality of representation for the remote viewer(s) 1300. However, some goods may have a surface that affects the camera's 1140 depth of field, e.g., the high refractive index of diamond. For such goods with a variety of refraction, it would be desirable to reduce the exposure (analogous to the aperture setting) and increase the gain, which may increase the depth of field and reduce the refractive effect to ensure the depth captures the maximum quality of representation. By contrast, metal goods such as gold and silver may have different reflection issues (due to surface design) that may need to be addressed. In such instances, it may be desirable to increase exposure. Further, if a precious stone is on display, a loupe, microscope or some other magnifying device (not shown) can be coupled to the camera 1140 lens to show certain aspects of the stone 1150, e.g., surface blemishes and inclusions that can verify identification and quality.

The camera 1140 is housed in a light box or light tent 1110 having two side walls, 1117 and 1118, a back wall 1119, a top 1115 and an interior bottom surface 1116. The color of these walls and surface can affect the lighting with the box 1110, and different colors may be more suitable for certain finished goods. For example, colored precious stones would display well with white walls and surfaces. Black walls and surfaces could serve as an effective contrast to white gold or silver products. A support stand 1130 in the light box 1110 is used to suspend the camera 1140 in the middle of the light box 1110 over the finished good, e.g., jewelry 1150. Light sources/lamps 1120 are used with the light box 1110 (inside or outside), one situated next to each side wall 1117 and 1118, to enhance the lighting within the light box 1110, thereby enhancing the visual display of the finished good 1150. Alternative light boxes 1110 known in the art can be used. Some light boxes 1110 may have an integrated light source, such as the lightbox and associated hardware described in U.S. Pat. No. 7,369,761, which is incorporated by reference in its entirety.

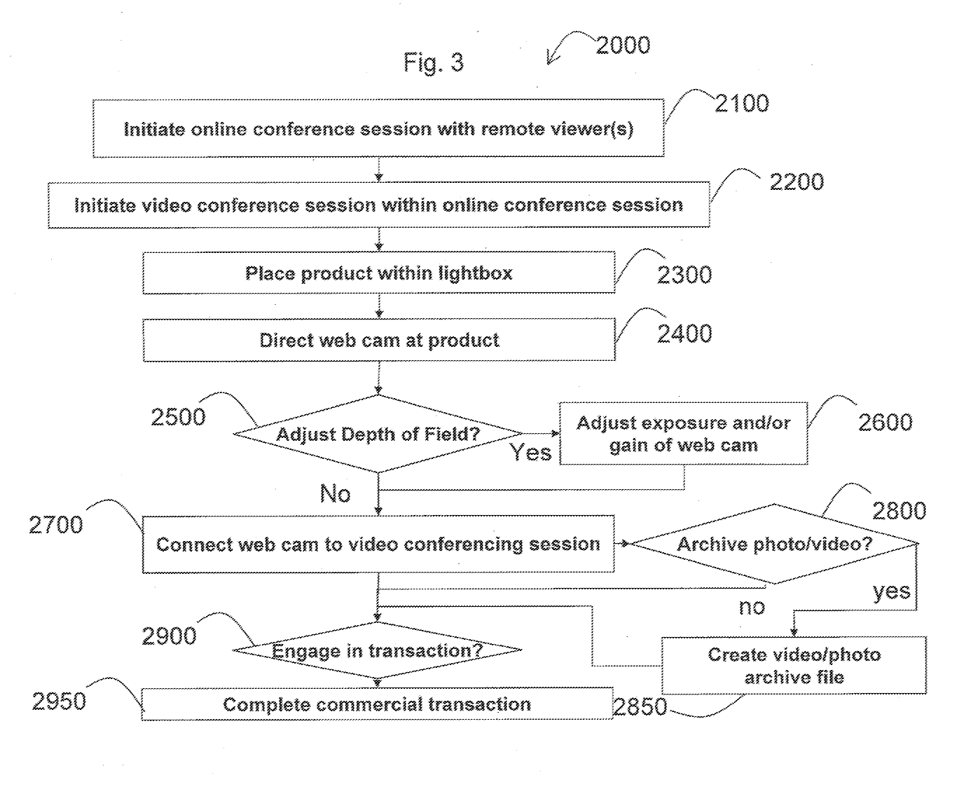

Turning to FIG. 3, a process 2000 of operation of the system 1000 is shown. A presenter can initiate a private and secure live interactive online conference session between the computing device 1145 of the online presentation system 1100 and one or more remote viewers' 1300 computing device using the conferencing system 1200 (Action Block 2100). The presenter can then initiate a video conference within the live interactive online conference session (Action Block 2200). The presenter can then place the product for presentation within the lightbox 1110 (Action Block 2300), and direct a camera 1140 (preferably a web cam) at the product (Action Block 2400). If the depth of field needs to be adjusted (Decision Block 2500), the presenter can adjust the exposure and/or gain of the camera 1140 to increase depth of field (Action Block 2600). If the camera 1140 is providing a quality representation of the product, then the presenter can connect the camera 1140 to the video conferencing session (Action Block 2700). If the presenter wishes to archive video or photos of the product for marketing purposes, for example, (Decision Block 2800), either the online presentation system 1100 or the online conferencing system 1200 can create and store the file for later use (Action Block 2850). If the parties are ready to engage in a business transaction (Decision Block 2900), the presenter can then complete the transaction (Action Block 2950) with the electronic commerce system 1500, e.g, PayPal.

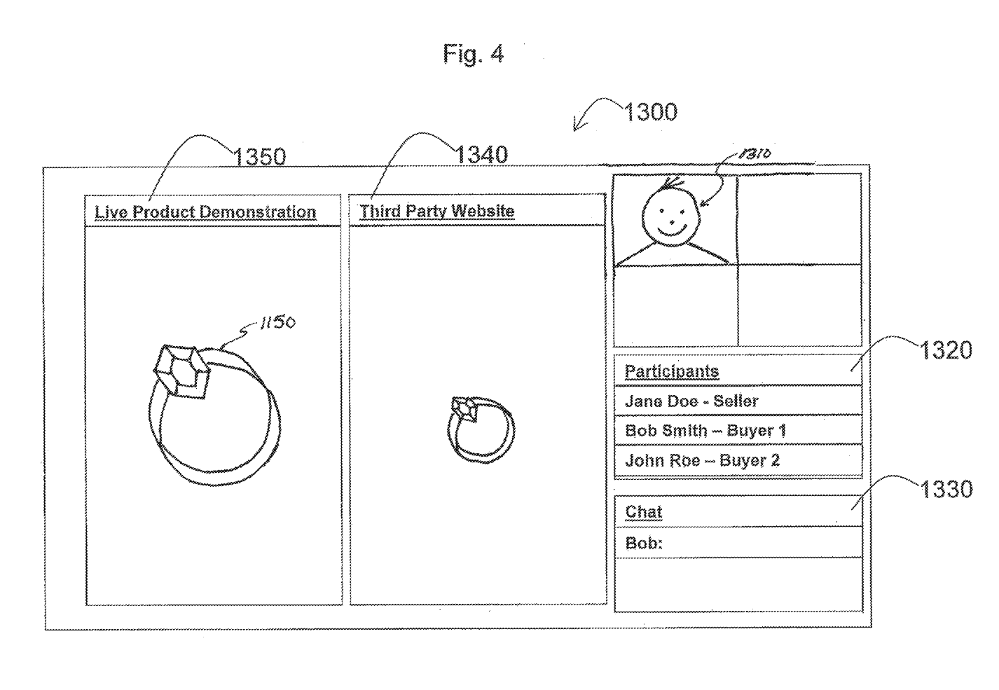

Once the remote viewer 1300 engages the live interactive online conferencing session with a video conference session established, a user interface is shown. Turning to FIG. 4, an exemplary user interface is shown on a remote viewer's 1300 computing device. The user interface includes a live interactive product demonstration window 1350 that retrieves the data from the camera 1140 located within the online presentation system 1100, e.g., live interactive real time video of the product-in this example jewelry 1150. If a webcam with video is utilized to transmit an interactive real-time video feed of the product 1150, e.g., if the process shown in FIG. 3 is followed, high quality interactive video can be displayed within the live product demonstration window 1350 with acceptable real time performance. Because a light box 1110 with a controlled lighting environment 1120 is used, and the depth of field is optimized, the product 1150 can be shown with high clarity in its truest form without misrepresentation. Not only will such a system show the quality of the product 1150, but also features to indicate authenticity, such as barcodes, or intricate signature patterns. The user interface can also show the participants 1310 of the video conference, e.g., the presenter/seller, via a separate camera (not shown), a list of the participants 1320, and a chat session 1330 that allows for the participants to text each other. The participants can also simultaneously hold an audio conference (not shown). The user interface can also display a presenter/seller's associated website 1340, which may allow for seller initiated sales presentations and may include an e-commerce system, e.g., 1500, such as Pay Pal, to complete business transactions.

In effect, the system 1000 allows for the sales person and buyer to emulate the traditional in person engagement through visual accuracy and live/real time interaction. It allows the buyer to visually inspect the product at any angle they request in real time with quality representation, and ask questions with immediate feedback (e.g., rotate item 1150, invert it, measure it, zoom into it, and perhaps even wear it). This interactive live/real time face-to-face online meeting allows both parties to engage in an in depth discussion simulating the traditional personal sales engagement, over the sales counter, thereby creating the same sense of trust and comfort essential in facilitating commerce while removing costs and potential dangers associated with the traditional in store engagements and addressing concerns buyers may have with other existing online commerce systems.

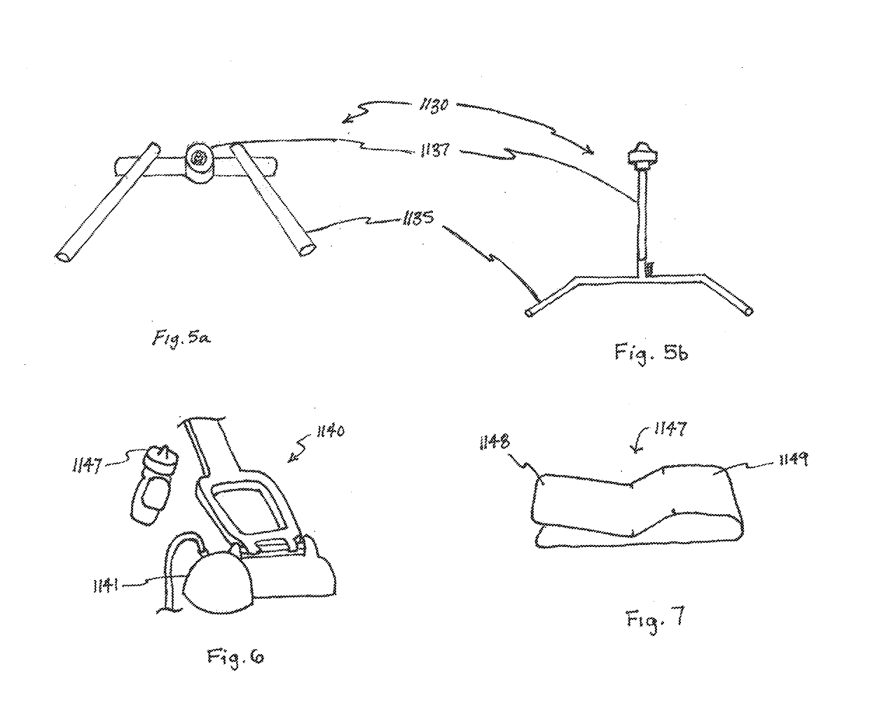

Turning to FIGS. 5a and 5b, it is preferable to suspend or support the camera 1140 to focus the lens on the finished good 1150 against a clean background. Further, it would be preferable to not have any portion of the support/suspension system in view. One solution is to use the support stand 1130 shown in FIGS. 5a and 5b placed against the back wall 1119 of the light box 1110. As opposed to a traditional tripod, this particular stand 1130 has a rod 1137 (to support the camera 1140) with legs 1135 configured as shown in FIGS. 5a and 5b, where the legs 1135 connect to the base of the rod 1137 and lay flat extending outward from the rod 1137, thereby creating an open space just below the lens of the camera 1140 that is easily accessible to the presenter. The rod 1137 can extend and rotate to adjust the position of the camera 1140.

Turning to FIG. 6, some web cams, e.g., Logitech Webcam 9000, position their lens 1141 to the side. If the web cam is mounted directly on support rod 1137, then the lens will be off center; however, it is preferable to align the lens directly over the point where the camera 1140 is mounted to the support rod 1137, which places the lens along the stand's 1130 vertical axis. One approach to address this issue is to use a clip 1147 shown in FIG. 7. The clip 1147 is formed with a sheet of malleable metal bent into a U shape. The U portion 1149 is designed to hold the camera 1140 in place, and the end portion 1148 is designed to be secured to the top of the support rod 1137 while the U portion 1149 holds the camera 1140 off center, thereby causing the lens 1141 to be centered over the vertical axis of the support rod 1137.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions. For example, this invention is particularly suited for presentation of small goods, such as jewelry, stones or items of value or great detail; however, the invention can be used for any product in general. As a further example, each feature of one embodiment can be mixed and matched with other features shown in other embodiments. Additionally and obviously, features may be added or subtracted as desired. Accordingly, the invention is not to be restricted except in light of the attached claims and their equivalents.

What is claimed is:

1. An online computing system that enables interactive live/real-time presentation of small goods on client computing devices communicatively coupled to a wide area network comprising:
an online conferencing system capable of initiating a video conferencing session communicatively coupled to the wide area network;
a computer operatively coupled to a web cam, wherein the computer communicatively couples the web cam to the video conferencing session through the wide area network, and further wherein the web cam has a lens directed at the small goods; and
a light box, having one or more light sources, substantially housing said small goods.

2. The online computing system of claim 1, wherein the web cam is suspended in the center of the light box with a support stand.

3. The online computing system of claim 2, wherein a clip secures the web cam to the support stand.

4. The online computing system of claim 2, wherein the lens is substantially aligned with a vertical axis of the support stand.

5. The online computing system of claim 1, wherein the online conferencing system comprises at least one network enabled computing device.

6. The online computing system of claim 5, wherein the computer is operable to record and store the video conferencing sessions, and wherein the network enabled computing device is operable to remotely access the stored video conferencing session.

7. The online computing system of claim 5, wherein the at least one network enabled computing device comprises at least one of: a personal computer, a tablet and a smart phone.

8. The online computing system of claim 1, wherein the video conferencing session includes desktop sharing.

9. The online computing system of claim 1, wherein the webcam includes controls for exposure and gain operable to adjust the depth of field of the webcam.

10. The online computing system of claim 1, wherein the small goods are at least one of: jewelry, precious metals, and precious stones or small goods with intricate detail or value.

11. The online computing system of claim 1, further comprising a magnifying device positioned between the web cam and the small goods.

12. The online computing system of claim 1, wherein the light box comprises two side walls, a back wall, and a top, and wherein light sources are positioned internal to at least one of: the side walls, the back wall, and the top.

13. A method for providing an interactive live/real-time presentation of small goods on one or more client computing devices communicatively coupled to a wide area network comprising:
establishing an interactive live/real-time online conferencing session with the one or more client computing devices;
establishing a video conferencing session within the interactive live/real-time online conferencing session coupled to the wide area network;
coupling a web cam, having a depth of field, to the video conferencing session through the wide area network, the web cam including controls for exposure and gain;
directing said web cam at said small goods;
providing a light box that substantially surrounds said small goods; and
controlling the depth of field of said web cam by adjusting the controls for exposure and gain.

14. The method of claim 13, further comprising the step of: suspending the web cam in the center of the light box with a support stand.

15. The method of claim 13, further comprising the step of: positioning a magnifying device between the web cam and the small goods.

16. The method of claim 13, further comprising the steps of:
recording the online conferencing sessions;
storing the online conferencing session on a storage device coupled to the wide area network; and
enabling the client computing devices to retrieve the stored online conferencing session via the wide area network.

17. An online computing system that enables interactive live/real-time presentation of small goods on client computing devices communicatively coupled to a wide area network comprising:
an online conferencing system capable of initiating a video conferencing session communicatively coupled to the wide area network, the online conferencing system comprising at least one network enabled computing device;
a second network enabled computing device connected to a web cam, the web cam having a lens directed at the small goods, the web cam having controls for adjusting gain and exposure;
a light box substantially housing said small goods, the light box including at least one light source external to a light box wall; and
a web cam is suspended in the center of the light box with a support stand;
wherein the second network enabled computing device communicatively couples the web cam to the video conferencing session through the wide area network; and
wherein the second network enabled computing device is operable to record and store the video conferencing sessions.

18. The online computing system of claim 17, wherein the second network enabled computing device includes at least one of a personal computer, a tablet, or a smart phone.

19. The online computing system of claim 17, wherein the second network enabled computing device is communicatively coupled to the wide area network via a wireless network device.

20. The online computing system of claim 17, wherein the webcam includes a magnifying device.
